(19) United States
(12) Patent Application Publication
(10) Pub. No.: US 2003/0150419 A1
(43) Pub. Date: Aug. 14, 2003

(54) Piston having ceramic-coated ring groove

(76) Inventors: Mehdi Daragheh, Peterborough (GB); Andrew McGilvray, Stamford (GB)

Correspondence Address: CATERPILLAR INC., 100 N.E. ADAMS STREET, PATENT DEPT., PEORIA, IL, 616296490

(21) Appl. No.: 10/323,583

(22) Filed: Dec. 18, 2002

(30) Foreign Application Priority Data
Dec. 27, 2001 (GB) 0131007.7

(51) Int. Cl. F02F 1/00

(52) U.S. Cl. 123/193.6

(57) ABSTRACT

In conventional pistons for internal combustion engines made from aluminum, magnesium, or the like, protection must be provided in the area in and around the ring grooves due to the wear and resultant microwelding between the piston ring groove and associated piston ring. One solution has been to cast the piston head around a separate protective ring made from steel or a similar material, which is costly and can negatively effect reliability and durability. In accordance with this invention, a hard ceramic reinforcing layer is provided on the outer surface of the piston in the area within the ring groove using a plasma electrolytic oxidation process. In this manner, the complexity and cost of the piston assembly is reduced while improving the reliability and durability. A piston according to this invention can be used to improve existing engine design that use a separate protective ring or can be used in new, cleansheet engine designs.

### DESCRIPTION

1. Technical Field

This invention relates to a piston for an internal combustion engine, and more particularly, to a piston in which the outer surface of the piston within the ring groove is coated with a hard ceramic layer.

2. Background

In conventional aluminum pistons for compression ignition internal combustion engines, the area around the ring groove formed in the aluminum piston body is traditionally protected using an iron or steel ring. Although this arrangement has worked well, room for improvement exists because the use of a separate reinforcing ring is costly and adds complexity to the piston, which in turn has a negative effect on durability and reliability.

One known solution to improve the durability and wear characteristics of aluminum is to form a hard ceramic layer on the outer surface of an aluminum body using plasma electrolytic oxidation, an example of which is shown in EP1050606A to Isle Coat Limited. In this manner, a hard layer of aluminum oxide, for example, is atomically bonded to the aluminum body. With respect to aluminum or magnesium pistons, it is known to use a plasma electrolytic oxidation process to provide a thermal barrier coating, for example, on the crown portion of the piston. However, providing such a thermal barrier coating to the piston crown does not provide any protection against wear or micro-welding (small-scale fusing of two components through excessive wear between them) which can result from such wear in other areas of the piston, such as the area adjacent the ring groove. This invention is directed to overcoming one or more of the problems described above.

### SUMMARY OF THE INVENTION

According to one aspect of the invention, a piston for an internal combustion engine comprises a piston body having at least one peripheral ring groove extending around the outer surface thereof. The ring groove has an internal surface that is coated by a hard ceramic layer. The hard ceramic layer is formed by plasma electrolytic oxidation.

According to another aspect of the invention, a method of manufacturing a piston for an internal combustion engine is disclosed, where the piston includes a piston body having at least one annular ring groove extending around the outer surface thereof, and where the ring groove has an internal surface. The method includes the step of forming a hard ceramic layer on the internal surface of the ring groove by plasma electrolytic oxidation.

According to yet another aspect of this invention, a method of improving a design for an internal combustion engine is disclosed. The method comprises a first step of creating an initial engine design having an engine piston design in which a piston has as at least one annular ring groove extending around the outer surface thereof, the ring groove being protected by a separate protective ring secured to the outer surface. The method further comprises replacing the piston design with a new engine piston design in which a piston has at least one annular ring groove extending around the outer surface thereof, the ring groove having an internal surface that is coated by a hard ceramic layer formed by plasma electrolytic oxidation. The new engine piston design does not include a separate protective ring.

Other features and aspects of this invention will be apparent from the following description and the accompanying drawings.

### BRIEF DESCRIPTION OF THE DRAWINGS

FIG. 1 is a side view of a first embodiment of a piston assembly in accordance with this invention;

FIG. 2 is a cross sectional view of the piston assembly shown in FIG. 1;

FIG. 3 is a detail of the cross sectional view shown in FIG. 2;

FIG. 4 is a cross sectional view of a second piston assembly in accordance with this invention; and

FIG. 5 is a schematic cross sectional view of an internal combustion engine in accordance with this invention.

### DETAILED DESCRIPTION

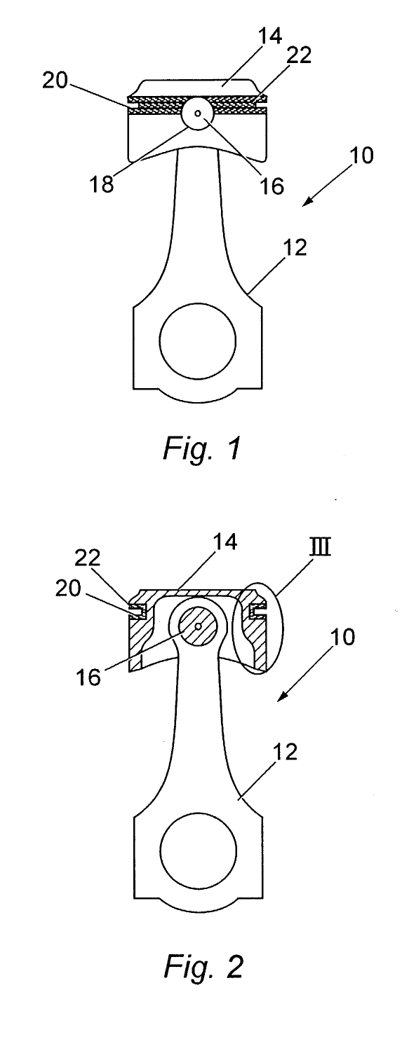

With reference to FIG. 1, there is shown an aluminum piston assembly, generally designated 10. The piston assembly comprises a connecting rod 12 and a piston 14. The connecting rod 12 and piston 14 are connected together by a wrist pin 16 which is received through opposed openings 18 in the piston 14 and a pin fitting (not shown) in the connecting rod 12.

The piston 14 is provided with at least one piston ring groove 20 around its circumference for the receipt of a respective piston ring (not shown). A hard ceramic oxide coating 22 is provided peripherally about the outer surface of the piston 14 within the piston ring groove 20. Optionally, the coating may be provided both within and adjacent the piston ring groove 20. The ceramic oxide coating 22 is applied by way of plasma electrolytic oxidation (PEO), which will be described in more detail below.

FIG. 2 shows a cross sectional view of the piston assembly 10 shown in FIG. 1. For illustrative purposes, the ceramic oxide coating 22 is shown thicker than it would be in use. In reality, the preferred thickness of the coating 22 is in the range of 1-50 μm, although the actual thickness of the coating 22 will be determined by the required wear resistance and the thermal insulating effect of the coating. If the coating is too thick, the thermal insulating effect could lead to the piston becoming too hot, which could in turn lead to the burning of oil in the cylinder, and hence the creation of carbon deposits between the piston and cylinder liner. The coating 22 itself is in practice comprised of three layers: a thin transitional layer between the piston head metal and the upper layers, providing an atomic bond between the coating 22 and the piston 14; an intermediate functional layer providing the hardness and wear resistance; and an external layer representing 30-40% of the total coating thickness which provides a base for paints or a secondary coating.

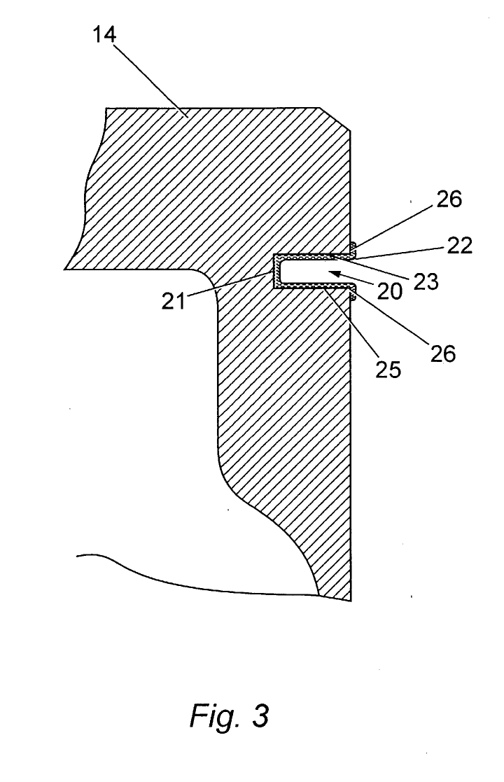

FIG. 3 shows a detail view of the piston 14 of the piston assembly 10 shown in FIG. 2. The ring groove 20 has a side wall 21 and opposing upper and lower walls 23,25. It can be seen clearly from FIG. 3 that the hard ceramic coating 22 coats both the areas 26 above and below the ring groove 20 and the walls 21,23,25 of the ring groove 20 itself. As a result, the surface area covered by the ceramic coating 22 is protected against wear occurring between the ring groove and the piston ring itself.

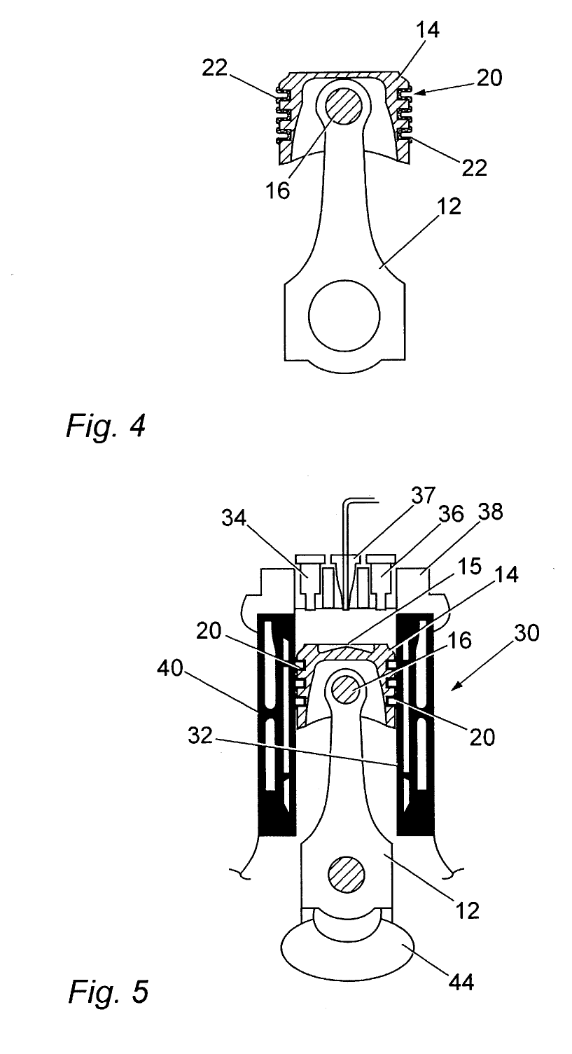

FIG. 4 shows a second embodiment of a piston assembly. The embodiment of FIG. 4 shares the same components as the embodiment shown in FIGS. 1-3, except that the piston 14 of this embodiment has three ring grooves 20 for receiving a corresponding number of piston rings therein. The person skilled in the art will understand that any number of ring grooves and piston rings may be provided as appropriate. Each ring groove 20 is coated by the hard ceramic coating 22.

FIG. 5 shows a piston assembly similar to that of FIG. 4 within a conventional internal combustion engine 30. In this example the engine 30 is a compression ignition engine. It should be noted that in the piston assembly of FIG. 5 the piston rings have been removed for illustrative purposes and that the piston 14 of this embodiment includes a combustion bowl 15 in the top surface thereof. The piston assembly is located within a cylinder 32 having an intake valve 34, an exhaust valve 36 and a fuel injector 37. The engine contains a head 38 for housing the valves 34,36 and injector 37 and a block 40 that contains the cylinder 32. The connecting rod 12 of the piston assembly is connected to a crankshaft 44.

Industrial Applicability

The method of application of the hard ceramic coating to the piston head will now be described in more detail. The application of the ceramic coating is by way of plasma electrolytic oxidation (PEO). The particulars of the PEO process are known to those skilled in the art, and the PEO process is offered commercially by Keronite Limited of Cambridge, UK, whose licensees include Poeton Industries Limited of Gloucester, UK and Metronic GmbH of Veitshochheim, Germany. The PEO procedure is similar to that of anodizing in that an electric power supply and electrolyte bath are used, the piston head acting as one electrode and the bath acting as the other electrode. However, PEO produces harder coatings than anodizing while using more environmentally friendly alkali electrolytes and a specially modulated AC voltage. During the PEO process, air is bubbled through the electrolyte and, when the AC voltage is applied, the piston head gives off sparks which create a plasma discharge around the component. These sparks melt the metal surface of the piston head at the points of highest current density, depositing a ceramic oxide coating which then freezes as the electrolyte again envelopes these areas. The coating gradually builds up during PEO at an approximate rate of 1 μm per minute.

In order that only the areas adjacent and within the piston ring groove are coated during the PEO process, a suitable masking paint or lacquer is applied to the remainder of the piston head prior to the PEO. In this way, surface oxidation will only occur on the non-masked portion of the piston head—the area of the piston ring groove. Where the piston head has two or more ring grooves, the area of each ring groove may be subjected to PEO if desired.

The precise composition of the ceramic coating depends upon the chemical composition of the metal or alloy being treated. It is composed primarily of the oxides of the main components in the alloy, such as, for example, A12O3 where an aluminum alloy is treated.

The present invention can reduce wear between the piston ring and piston head in the area of the piston ring groove. As there is minimal wear between the components, microwelding of the piston ring to the piston head is prevented, thus facilitating quick replacement of the piston rings when necessary.

The coating of the piston ring groove area to reduce wear using PEO can replace the more complicated and costly use of a cast-in reinforcing ring. Usually, where a reinforcing ring is used, the piston head is cast around the ring, resulting in a relatively complex production procedure which is disadvantageous in respect of both production time and cost. The present invention provides a quicker and more cost effective method of preventing wear and the resultant effects thereof in the area of the piston ring groove and the piston ring itself.

Although the preferred embodiments of this invention are described herein, those skilled in the art will recognize that variations and modifications may be made without departing from the scope of the following claims. For example, although the pistons illustrated in FIGS. 1 and 4 are of flat-top configuration, those skilled in the art will recognize that this invention is equally applicable to other piston configurations. Other configurations include pistons having a combustion bowl or crater formed in the top surface of the piston, as shown in FIG. 5. Those skilled in the art will also recognize that this invention is applicable to both one-piece piston configurations as illustrated herein and multi-piece (e.g. articulated) piston configurations.

Although the piston assemblies described herein have either one or three piston rings and corresponding grooves, the piston assembly may also have two, four or more rings and associated grooves depending on the application. Furthermore, materials other than aluminum may be used for the piston head, such as magnesium, titanium or other suitable light metals or their alloys. Finally, although the embodiment of the internal combustion engine described above is a compression ignition engine, the present invention may equally be applied in respect of a spark ignition engine.

Although the preferred embodiments of this invention have been described herein, improvements and modifications may be incorporated without departing from the scope of the following claims.

What is claimed is:

1. A piston for an internal combustion engine, said piston having at least one peripheral ring groove extending around the outer surface thereof, wherein the ring groove has an internal surface which is coated by a hard ceramic layer, said hard ceramic layer being formed by plasma electrolytic oxidation.

2. The piston according to claim 1 wherein said internal surface of said ring groove comprises a side wall surface and opposing upper and lower wall surfaces, each surface being coated by said hard ceramic layer.

3. The piston according to claim 2 wherein said hard ceramic layer further coats a portion of said outer surface adjacent said ring groove.

4. The piston according to claim 1 wherein said hard ceramic layer only coats the internal surface of said ring groove.

5. The piston according to claim 1 wherein said hard ceramic layer only coats the internal surface of said ring groove and a portion of said outer surface adjacent said ring groove.

6. The piston according to claim 1 wherein said piston is formed from a material selected from the group consisting of aluminum, magnesium, titanium, alloys thereof, and inter-metallides thereof.

7. The piston according claim 1 wherein said piston has a plurality of ring grooves formed in the outer surface thereof, each ring groove having an internal surface which is coated by a hard ceramic layer.

8. The piston according to claim 7 wherein said hard ceramic layer only coats the internal surface of each of said ring grooves.

9. The piston according to claim 7 wherein said hard ceramic layer only coats the internal surface of each of said ring grooves and a portion of said outer surface adjacent each of said ring groove.

10. A method of manufacturing a piston for an internal combustion engine, said piston having at least one annular ring groove extending around the outer surface thereof, the ring groove having an internal surface, and said method including the step of:
forming a hard ceramic layer on the internal surface of said ring groove by plasma electrolytic oxidation.

11. The method according to claim 10 wherein said internal surface of said ring groove comprises a side wall surface and opposing upper and lower wall surfaces, each surface being coated by said hard ceramic layer.

12. The method according to claim 11 wherein said hard ceramic layer further coats a portion of said outer surface adjacent said ring groove.

13. The method according to claim 10 wherein said hard ceramic layer only coats the internal surface of said ring groove.

14. The method according to claim 10 wherein said hard ceramic layer only coats the internal surface of said ring groove and a portion of said outer surface adjacent said ring groove.

15. The method according to claim 10 wherein said piston is formed from a material selected from the group consisting of aluminum, magnesium, titanium, alloys thereof, and inter-metallides thereof.

16. The method according to claim 10 wherein said piston has a plurality of ring grooves formed in the outer surface thereof, the method including the step of forming a hard ceramic layer on the internal surface of each ring groove by plasma electrolytic oxidation.

17. The method according to claim 16 wherein said hard ceramic layer is formed only on the internal surface of each of said ring grooves.

18. The method according to claim 16 wherein said hard ceramic layer is formed only on the internal surface of each of said ring grooves and a portion of said outer surface adjacent each of said ring groove.

19. A method of improving a design for an internal combustion engine comprising the steps of:
creating an initial engine design having an engine piston design in which a piston has as at least one annular ring groove extending around the outer surface thereof, said ring groove being protected by a separate protective ring secured to the outer surface; and
replacing said piston design with a new engine piston design in which a piston has at least one annular ring groove extending around the outer surface thereof, the ring groove having an internal surface that is coated by a hard ceramic layer formed by plasma electrolytic oxidation, said new engine piston design not including a separate protective ring.

20. The method according to claim 19 wherein said hard ceramic layer is formed only on said internal surface of said ring groove and on a portion of said outer surface adjacent said ring groove.
